(19) United States
(12) Patent Application Publication
(10) Pub. No.: US 2007/0263015 A1
(43) Pub. Date: Nov. 15, 2007

(54) Multi-function key with scrolling

(75) Inventors: Pekka Ketola, Tampere (FI); Antti-Pekka Syrjanen, Berkshire (GB)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/789,463

(22) Filed: Apr. 24, 2007

Related U.S. Application Data
(63) Continuation-in-part of application No. 11/431,144, filed on May 9, 2006.

(51) Int. Cl. G09G 5/00

(52) U.S. Cl. 345/684

(57) ABSTRACT

The specification and drawings present a new method, apparatus and software product for combining scrolling with a multi-function key performance. A scrolling multi-function key module can comprise a multi-function key unit and a scroll touch sensor unit having an edge-like sensitive area substantially around the multi-function key unit for providing a scrolling movement of information, corresponding to the predetermined task and to the sliding movement of the object according to a predetermined criterion, on a display of an electronic device. A sensor module of the scroll touch sensor can comprise a plurality of electrodes (e.g., 4 capacitive electrodes) arranged in rows and columns to form a matrix and configured to provide Cartesian coordinates.

### PRIORITY AND CROSS-REFERENCE TO RELATED APPLICATION

This application is a continuation in part of and claims priority from U.S. patent application Ser. No. 11/431,144, filed May 9, 2006.

### TECHNICAL FIELD

This invention generally relates to electronic devices and more specifically to combining scrolling with a multi-function key performance.

### BACKGROUND ART

Many styles of input devices for performing operations in various electronic devices do exist. For example, the input devices may include (but are not limited to): buttons, switches, keyboards, mice, trackballs, touch pads, joy sticks, touch screens, etc. Each of these input devices has advantages and disadvantages that are taken into consideration when designing the electronic device. In handheld (e.g., portable) devices, the input devices are generally selected buttons and switches, which can be mechanical in nature and provide limited control regarding the movement of a cursor (or other selector) for making selection. It is also possible to use input devices utilizing touch-sensitive display screens, e.g., in personal digital assistants (PDA). When using a touch screen, a user makes a selection on the display screen by pointing directly to objects on the screen using a stylus or a finger.

The amount of personal content in mobile phones is rapidly increasing. The content is typically browsed in list or grid formats, such as a phonebook list or list of images. In most mobile phones there are dedicated keys for scrolling left/right or up/down. These keys can be satisfactory for performing simple tasks, but in tasks where active scrolling is needed often, for example with long lists, they may be difficult to operate and can easily produce errors (e.g., by wrong finger movements). A touch-based scroll tool (e.g., introduced by APPLE COMPUTERS) can be used to scroll lists, but such solution is not adequate in some applications, where the two-way scroll is not enough. In other words, the touch-based scroll tool by itself lacks the capability to be tuned and optimized for the numerous different tasks that are offered in modern mobile devices.

### DISCLOSURE OF THE INVENTION

According to a first aspect of the invention, a method comprises: providing a key input by a user input action for a multi-function key unit of a scrolling multi-function key module of or connected to an electronic device, the key input selecting a predetermined task; providing a scroll actuating input by a further user input action using a sliding movement of an object on a sensitive area of a scroll touch sensor unit of the scrolling multi-function key module, wherein the scroll touch sensor unit is configured to have a sensitive area substantially around the multi-function key unit; and providing, in response to the key input and to the scroll actuating input, a scrolling movement of information corresponding to the predetermined task on a display of the electronic device, wherein the scrolling movement of the information on the display further corresponds to the sliding movement of the object according to a predetermined criterion for combining scrolling with a multi-function key performance in the electronic device.

According further to the first aspect of the invention, the scrolling multi-function key module may be connected to the electronic device by an electrical or wireless connection.

Further according to the first aspect of the invention, the sliding movement may be detected by a plurality of electrodes comprised in a sensor module of the scroll touch sensor unit, wherein the electrodes are arranged in rows and columns to form a matrix and configured to provide Cartesian coordinates of a location of the object during the sliding movement on the sensitive area of the scroll touch sensor unit. Still further the plurality of electrodes may be capacitive electrodes. Yet still further, the plurality of electrodes may be four capacitive electrodes.

According yet further to the first aspect of the invention, the sensitive area may have a shape of at least one of: a) an edge, b) a substantially circular edge, c) an edge which completely surrounds the multi-function key unit, d) an edge which partially surrounds the multi-function key unit, e) an oval edge, and f) a substantially rectangular or square edge.

According further to the first aspect of the invention, the multi-function key may be one of: a) a 5-way navigation key, b) a 9-way navigation key, and c) an analogue navigation key.

Still further according to the first aspect of the invention, the key input and the scroll actuating input may be provided by a way of a mechanical touch of the object which is at least one of: a) a stylus and b) a finger.

According further to the first aspect of the invention, the scroll touch sensor may comprise a sensor module configured to detect the sliding movement of the object using at least one of: a resistive sensing method, a capacitive sensing method, a surface acoustic wave sensing method, a pressure sensing method, an optical detection method and an inductive method.

According still further to the first aspect of the invention, before the providing the scrolling movement of the information, the method may comprise: determining, according to the predetermined criterion, a rate of the scrolling of the information on the display using a speed of the sliding movement of the object.

According further still to the first aspect of the invention, the method may further comprise: providing a feedback signal about the sliding movement of the object or about the scrolling of the information on the display using at least one of: a) a visual feedback, b) an audio feedback, and c) a haptic feedback.

According yet further still to the first aspect of the invention, the sliding movement of an object on the sensitive area in a clockwise direction may correspond to the scrolling movement of the information on the display in a pre-selected direction, and the sliding movement of an object on the sensitive area in a counter-clockwise direction may correspond to scrolling movement of the information on the display in a further direction opposite to the pre-selected direction.

Yet still further according to the first aspect of the invention, the electronic device may be configured to alter the predetermined criterion in response to a scroll function input.

Still further according to the first aspect of the invention, the electronic device may be a wireless communication device, a portable electronic device, a non-portable electronic device, a computer, a portable computer, a mobile communication device, a wireless camera phone, or a mobile phone.

According to a second aspect of the invention, a computer program product comprises: a computer readable storage structure embodying computer program code thereon for execution by a computer processor with the computer program code, wherein said computer program code comprises instructions for performing the method of the first aspect of the invention, indicated as being performed by any component or a combination of components of the electronic device.

According to a third aspect of the invention, an electronic device, comprises: a scrolling multi-function key module, comprising: a multi-function key unit, responsive to a key input provided by a user input action, the key input selecting a predetermined task; a scroll touch sensor unit, responsive to a scroll actuating input provided by a further user input action using a sliding movement of an object on a sensitive area of the scroll touch sensor unit, wherein the scroll touch sensor unit is configured to have a sensitive area substantially around the multi-function key unit; a display configured to display information; and a processor configured to provide a scrolling movement of the information corresponding to the predetermined task on the display, wherein the scrolling movement of the information on the display further corresponds to the sliding movement of the object according to a predetermined criterion for combining scrolling with a multi-function key performance in the electronic device.

Further according to the third aspect of the invention, the a scroll touch sensor unit may comprise a sensor module with a plurality of electrodes configured to detect the sliding movement, wherein the electrodes are arranged in rows and columns to form a matrix and configured to provide Cartesian coordinates of a location of the object during the sliding movement on the sensitive area. Still further, the plurality of electrodes may be capacitive electrodes. Yet still further, the plurality of electrodes may be four capacitive electrodes.

Still further according to the first aspect of the invention, the sensitive area may have a shape of at least one of: a) an edge, b) a substantially circular edge, c) an edge which completely surrounds the multi-function key unit, d) an edge which partially surrounds the multi-function key unit, e) an oval edge, and f) a substantially rectangular or square edge.

Still yet further according to the third aspect of the invention, the multi-function key may be one of: a) a 5-way navigation key, b) a 9-way navigation key, and c) an analogue navigation key.

According further to the third aspect of the invention, the key input and the scroll actuating input may be provided by a way of a mechanical touch of the object which is at least one of: a) a stylus and b) a finger.

According still further to the third aspect of the invention, the scroll touch sensor may comprise a sensor module configured to detect the sliding movement of the object using at least one of: a resistive sensing method, a capacitive sensing method, a surface acoustic wave sensing method, a pressure sensing method, an optical detection method and an inductive method.

According yet further still to the third aspect of the invention, the processor may be configured to determine, according to the predetermined criterion, a rate of the scrolling of the information on the display using a speed of the sliding movement of the object.

According further still to the third aspect of the invention, the sliding movement of an object on the sensitive area in a clockwise direction may correspond to the scrolling movement of the information on the display in a pre-selected direction, and the sliding movement of an object on the sensitive area in a counter-clockwise direction may correspond to scrolling movement of the information on the display in a further direction opposite to the pre-selected direction.

Yet still further according to the third aspect of the invention, the electronic device may be configured to alter the predetermined criterion in response to a scroll function input.

According to a fourth aspect of the invention, a scrolling multi-function key module, comprises: a multi-function key unit, responsive to a key input provided by a user input action, the key input selecting a predetermined task; and a scroll touch sensor unit, responsive to a scroll actuating input provided by a further user input action using a sliding movement of an object on a sensitive area of the scroll touch sensor unit, wherein the scroll touch sensor unit is configured to have a sensitive area substantially around the multi-function key unit, wherein an electronic device is configured to provide a scrolling movement of information corresponding to the predetermined task on a display of the electronic device, wherein the scrolling movement of the information on the display further corresponds to the sliding movement of the object according to a predetermined criterion for combining scrolling with a multi-function key performance in the electronic device.

According further to the fourth aspect of the invention, the scrolling multi-function key module may be a part of the electronic device.

Further according to the fourth aspect of the invention, the scrolling multi-function key module may be connected to the electronic device by an electrical or wireless connection.

Still further according to the fourth aspect of the invention, the scroll touch sensor unit may comprise a sensor module with a plurality of electrodes configured to detect the sliding movement, wherein the electrodes are arranged in rows and columns to form a matrix and configured to provide Cartesian coordinates of a location of the object during the sliding movement on the sensitive area. Still further, the plurality of electrodes may be capacitive electrodes. Yet still further, the plurality of electrodes may be four capacitive electrodes.

According yet further to the fourth aspect of the invention, the sensitive area may have a shape of at least one of: an edge, a substantially circular edge, an edge which completely surrounds the multi-function key unit, an edge which partially surrounds the multi-function key unit, an oval edge, and a substantially rectangular or square edge.

According still further to the fourth aspect of the invention, the multi-function key may be one of: a 5-way navigation key, a 9-way navigation key, and an analogue navigation key.

According further still to the fourth aspect of the invention, the key input and the scroll actuating input may be provided by a way of a mechanical touch of the object which is at least one of: a stylus and a finger.

Yet still further according to the fourth aspect of the invention, the scroll touch sensor may comprise a sensor module configured to detect the sliding movement of the object using a resistive sensing method, a capacitive sensing method, a surface acoustic wave sensing method, a pressure sensing method, an optical detection method or an inductive method.

According further to the fourth aspect of the invention, the sliding movement of an object on the sensitive area in a clockwise direction may correspond to the scrolling movement of the information on the display in a pre-selected direction, and the sliding movement of an object on the sensitive area in a counter-clockwise direction may correspond to scrolling movement of the information on the display in a further direction opposite to the pre-selected direction.

### BRIEF DESCRIPTION OF THE DRAWINGS

For a better understanding of the nature and objects of the present invention, reference is made to the following detailed description taken in conjunction with the following drawings, in which:

FIG. 1 is a block diagram of an electronic device having a scrolling multi-function key module for combining scrolling with a multi-function key performance, according to an embodiment of the present invention;

FIGS. 2a, 2b and 2c are top views of a scrolling multi-function key module, wherein sensitive area of a scroll touch sensor unit has a shape of: a) a circular edge which completely surrounds the multi-function key unit as shown in FIG. 2a, b) a circular edge which partially surrounds the multi-function key unit as shown in FIGS. 2b and c) a substantially rectangular edge which partially surrounds the multi-function key unit as shown in FIG. 2c, according to embodiments of the present invention;

FIG. 3 is a schematic representation of an electronic device with a cross-sectional view of a scrolling multi-function key module for combining scrolling with a multi-function key performance, according to an embodiment of the present invention;

FIG. 4 is a schematic representation of a scrolling multi-function key module with a scroll touch sensor unit having a sensor module comprising four rectangular capacitive electrodes in a matrix layout as touch-sensors to provide Cartesian coordinates of a location of a sliding object on a sensitive area of the scroll touch sensor unit, according to an embodiment of the present invention; and

FIG. 5 is a flow chart for combining scrolling with a multi-function key performance in an electronic device, according to an embodiment of the present invention.

### MODES FOR CARRYING OUT THE INVENTION

A new apparatus, method and software product are presented for combining scrolling with a multi-function key performance for applications in an electronic device thus improving browsing capabilities of the electronic device without increasing the user interface complexity and without adding the overall surface area in the electronic device.

According to an embodiment of the present invention, a scrolling multi-function key module can comprise a multi-function key unit (e.g., a 5-way navigation key, a 9-way navigation key, an analogue navigation key, etc.) and a scroll touch sensor unit having a sensitive area substantially around the multi-function key unit. This sensitive area can have a shape of an edge (e.g., in a shape of a substantially circular edge, a substantially rectangular or square edge, an oval edge, etc.), which completely or partially surrounds the multi-function key unit. The electronic device may be (but is not limited to) a wireless communication device, a portable electronic device, a non-portable electronic device, a computer, a portable computer, a mobile communication device, a wireless camera phone, or a mobile phone. The multi-function key unit can have N keys (e.g., a 5-way navigation key, a 9-way navigation key, etc.) and each key may identify K functions (e.g., by consecutive pressing), wherein N and K are integers of at least a value of one and K multiplied by N equals two or more.

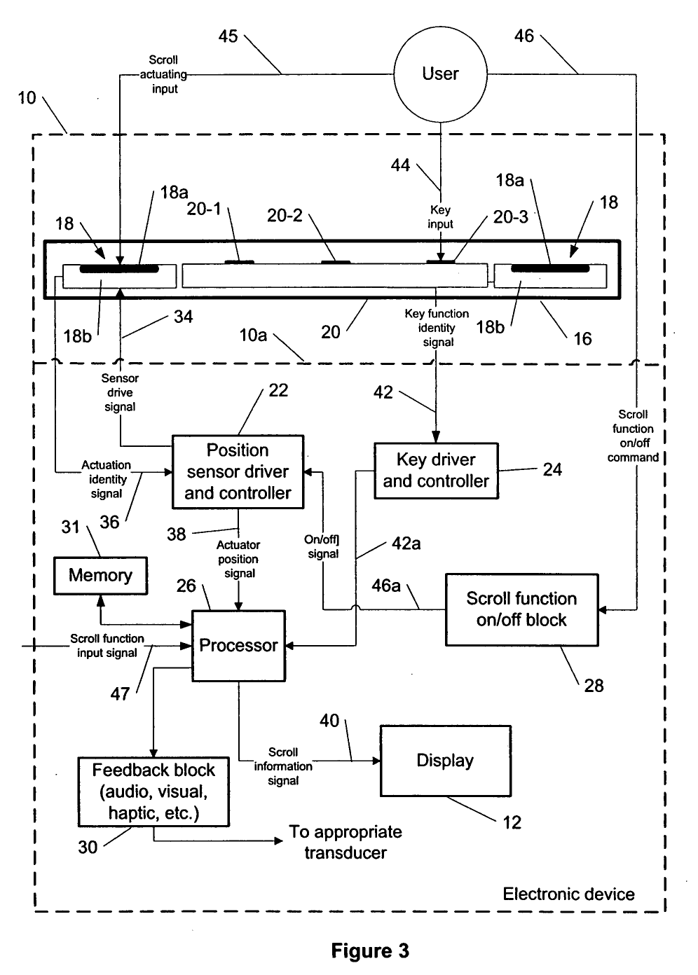

According to an embodiment of the present invention, a user can provide a key input by a user input action for the multi-function key thus selecting a predetermined task, e.g., to review a long list of items (other tasks may be scrolling multiple selections or viewing many pictures, etc.). Then, the user can provide a scroll actuating input by a further user input action using a sliding movement (or a continuous movement) of an object (e.g., a finger or a stylus) on the edge-like sensitive area of the scroll touch sensor unit. In response to the key input and to the scroll actuating input, the electronic device is configured to provide (e.g., see an example of FIG. 3) a scrolling movement of information corresponding to the predetermined task (i.e., to scroll the list) on a display of the electronic device, wherein the scrolling movement of said information on the display further corresponds to the sliding movement of the object according to a predetermined criterion.

For example, moving the object (i.e., the finger) clockwise on the sensitive area of the scroll touch sensor unit can advance the list on the display in one direction (e.g., “up” or “left”), whereas moving the finger counter-clockwise on the sensitive area of the scroll touch sensor unit will advance the list on the display in another opposite direction (e.g., “down” or “right”). Also the electronic device can be configured to determine, according to a predetermined criterion, a rate of the scrolling of the information on the display using a speed of the sliding movement of the object. Generally, the rate of scrolling can be changed to a new value (by a pre-selected increment) if the speed of the sliding movement reaches a pre-selected value and/or after maintaining said pre-selected value for a predetermined period of time.

Furthermore, according to an embodiment of the present invention, the actuating of the scroll touch sensor may be provided using a resistive sensing method, a capacitive sensing method, a surface acoustic wave sensing method, a pressure sensing method, an optical detection method, an inductive method and the like, or a combination thereof (e.g., a combination of capacitive and resistive touch methods). Moreover, the electronic device may be configured to switch the scrolling function “on” and “off”, e.g., by turning on and off the scroll touch sensor in response to a command from the user. Also, a feedback signal to a user about the sliding movement of the object (e.g., the finger) or about the scrolling of the information on the display can be provided using a visual feedback (e.g., the sensitive area of the scroll touch sensor unit can be lit when scrolling function is “on” or the light can follow the finger), an audio feedback (e.g., scrolling speed can be identified by a different pitch sound), a haptic feedback (e.g., scrolling speed can be identified by a different vibration frequency of the electronic device), and/or a tactile feedback (e.g., by integrating with keymat domes).

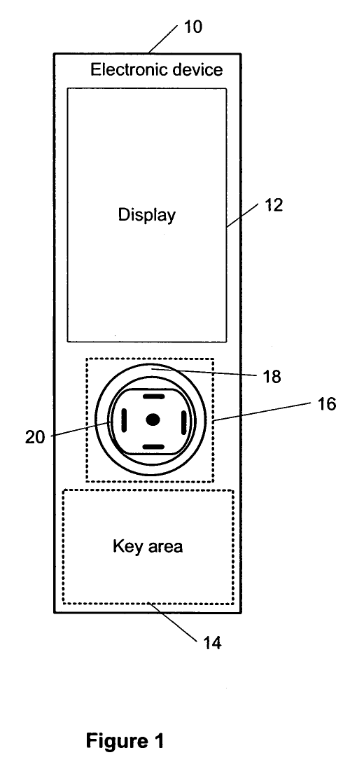

FIG. 1 shows an example among others of a block diagram of an electronic device (e.g., a mobile phone) 10 having a scrolling multi-function key module 16 for combining scrolling with a multi-function key performance along with a key block 14 and a display 12, according to an embodiment of the present invention. The key block 14 is optional in the device 10.

The module 16 comprises a multi-function key unit 20 and a scroll touch sensor unit 18 having a sensitive area (e.g., in a shape of a circular edge) substantially around the multi-function key unit 20. Actuating of sensors of the unit 18 may be provided using a resistive sensing method, a capacitive sensing method, a surface acoustic wave sensing method, a pressure sensing method, an optical detection method, an inductive method and the like. The module 16 can be used in a main user interface (UI) of the electronic device 10 as shown in FIG. 1, in a cover UI or the like.

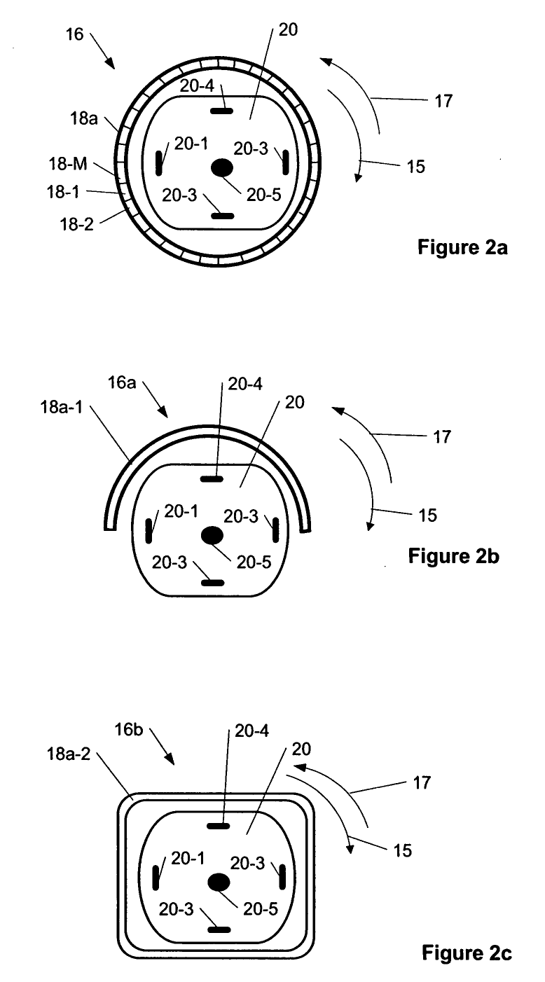

FIG. 2a shows an example among many others of a top view of a scrolling multi-function key module 16, wherein a sensitive area 18a of the scroll touch sensor unit 18 has a shape, e.g., of the circular (or substantially circular) edge which completely surrounds the multi-function key unit 20.

For example, moving the object (i.e., the finger) clockwise in a direction 15 on the edge-like sensitive area 18a of the scroll touch sensor unit 18 will advance information corresponding to the predetermined task (e.g., a list, a selection, a picture, etc.) on the display 12 (shown in FIG. 1) in one direction (e.g., “up” or “left”), whereas moving the finger counter-clockwise in a direction 17 on the sensitive area 18a of the scroll touch sensor unit 18 (e.g., shown in FIGS. 1 and 3) will advance the list on the display 12 in another direction (e.g., “down” or “right”). Also it is noted that in one possible embodiment, the sensitive area 18a of the scroll touch sensor unit 18 can be divided into M independent sectors (M=32 in the example of FIG. 2a) 18-1, 18-2, . . . , 18-M such that when the object (e.g., the finger) slides across the edge-like sensitive area 18a of the unit 18, multiple position signals from all the sectors out of sectors 18-1, 18-2, . . . , 18-M which are in contact with the object can be used by the electronic device 10 for determining direction and a speed of the object which will define the scrolling movement of the information on the display 12 according to the predetermined criterion, as explained above. The multi-function key unit 20 in the example of FIG. 2a have 5 keys 20-1, 20-2, . . . , 20-5 and each key can identify multiple functions (e.g., by consecutive pressing).

FIG. 2b shows another example among many others of a top view of a scrolling multi-function key module 16a, wherein a sensitive area 18a-1 of the scroll touch sensor unit 18 has a shape of a circular edge which partially surrounds (half a circle) the multi-function key unit 20. The operation here is similar to the operation of the multi-function key module 16 shown in FIG. 2a with the only difference that in FIG. 2b, instead of going a full circle while sliding in one direction, the object can get back to the beginning of the edge (e.g., 180 degrees apart) and continue sliding in the same direction, thus facilitating continuing scrolling of the information on the display 12 in the same direction. The example shown in FIG. 2b provides further savings in space and sensor cost.

FIG. 2c shows another example among many others of a top view of a scrolling multi-function key module 16b, wherein a sensitive area 18a-2 of the scroll touch sensor unit 18 has a shape of a substantially rectangular edge which surrounds the multi-function key unit 20. The operation here is similar to the operation of the multi-function key module 16 shown in FIG. 2a with the only difference that the sensitive area 18a-2 in FIG. 2c substantially has a shape of a rectangle instead of a circle. The example shown in FIG. 2c may provide further savings in space.

FIG. 3 shows an example among others of a schematic representation of the electronic device 10 with a cross-sectional view of the scrolling multi-function key module 16 for combining scrolling with a multi-function key performance, according to an embodiment of the present invention. The scrolling multi-function key module 16 can be a part of the electronic device 10 or the module 16 can be a separate unit (e.g., a remote control) from an electronic device 10a as shown in FIG. 3. Then the module 16 can be connected to the electronic device 10a by an electrical or wireless connection.

The module 16 comprises the multi-function key 20 with the shown keys 20-1, 20-2 and 20-3, and the scroll touch sensor unit 18 which comprises the sensitive area 18a and a sensor module (area) 18b typically comprising one or a plurality of electrodes. The user can provide a scroll function on/off command to a scroll function on/off block 28 to turn on or off the sensors of the module 18b by providing an on/off signal 46a to a position sensor driver and controller 22 and subsequently turning on and off a sensor drive signal 34, respectively. During the operation of the electronic device 10, the user can provide a key input signal 44, e.g., to the key 20-3, as shown in FIG. 3, thus selecting a predetermined task (e.g., to review a long list of items). In response to the key input 44, the unit 20 provides a key function identity signal 42 to a key driver and controller 24 which forwards it (see signal 42a) to a processor 26. It is noted that the module 20 can generally be means for providing a key input or a structural equivalence (or equivalent structure) thereof. Also, the module 18 can generally be means for providing a scroll actuating input by a further user input action using a sliding movement of an object or a structural equivalence (or equivalent structure) thereof. Moreover, the module 26 can generally be means for providing the scrolling movement of information or a structural equivalence (or equivalent structure) thereof.

Then, the user can provide a scroll actuating input 45 using a sliding movement of a finger or a stylus on a sensitive area (edge) 18a of the scroll touch sensor unit 18. In response to the scroll actuating input 45, the sensors of the sensor module 18b can provide an actuation identity signal 36 to the position sensor driver and controller 22 which in response to the signal 36, can generate an actuator position signal 38 indicating, e.g., coordinates of the sensitive area 18a of the unit 18 touched by the user as a function of time, and can provide the signal 38 to a processor 26. The processor 26, using the signals 38 and 42a as inputs, can determine, e.g., a direction of the object movement, and/or the speed of sliding the object (the finger or the stylus) on the sensitive area (edge) 18a of the unit 18 and can further generate and provide (e.g., using a memory 31 storing information to be displayed) a scroll information signal 40 to facilitate a scrolling movement of information corresponding to the predetermined task (indicated by the signal 44) on the display 12 of the electronic device 10, wherein the scrolling movement of said information on the display further corresponds to the sliding movement of the object according to a predetermined criterion as described above.

It is noted that the electronic device 10 can be configured to be able to alter the predetermined criterion, if necessary, in response to a scroll function input 47 from a user provided to the processor 26. Also, a feedback signal to a user about the sliding movement of the object (e.g., the finger) or about the scrolling of the information on the display 12 can be provided using a feedback block 30 which provides an appropriate signal to corresponding transducers including (but not be limited to) a visual feedback (e.g., the sensitive area 18a of the scroll touch sensor unit 18 can be lit when scrolling function is “on” or the light can follow the finger), an audio feedback (e.g., scrolling speed can be identified by a different pitch sound), and/or a haptic feedback (e.g., scrolling speed can be identified by a different vibration frequency of the electronic device 10).

According to an embodiment of the present invention, the block 26, 22, 24, 28 or 30 can be implemented as a software block or a hardware block or a combination thereof. Furthermore, the block 26, 22, 24, 28 or 30 can be implemented as a separate block or can be combined with any other block of the electronic device 10 or it can be split into several blocks according to their functionality.

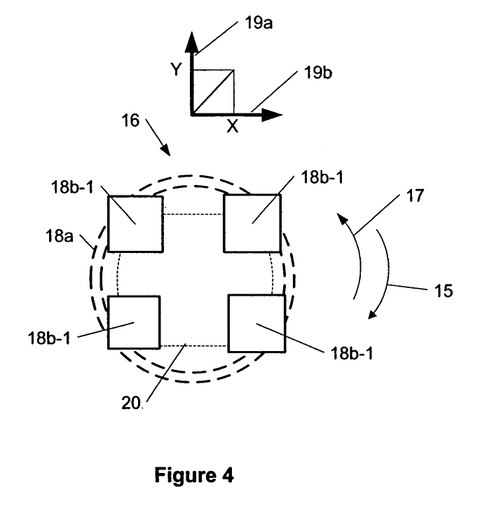

According to embodiment of the present invention, the sensor module 18b can detect the position of the object on the sensitive area 18 using different approaches, e.g., detecting polar or radial angles. According to a further embodiment of the present invention, the detecting of the position (or sliding movement) of the object on the sensitive area 18 can be provided by a sensor module 18b comprising a plurality of electrodes configured to detect the sliding movement, wherein the electrodes are arranged in rows and columns to form a matrix and configured to provide Cartesian coordinates of a location of the object during the sliding movement on the sensitive area 18a. For example, the plurality of electrodes can be capacitive electrodes (e.g., comprising 4 capacitive electrodes). The sensing electronics (e.g., the module 22 in FIG. 4) then can be used to detect a change in capacitance at the electrodes when the object (e.g., a finger) passes over the matrix.

FIG. 4 shows an example among others of a schematic representation of a scrolling multi-function key module 16 with a scroll touch sensor unit having a sensor module comprising four rectangular capacitive electrodes 18b-1, 18b-2, 18b-3 and 18b-4 in a matrix layout as touch-sensors to provide Cartesian coordinates (using X and Y directions shown as 19a and 19b) of a location of a sliding object on a sensitive area 18a of the scroll touch sensor unit, according to an embodiment of the present invention. The Cartesian coordinate system is used for the rows and columns which corresponds to X and Y positions of the object on the sensitive area 18a during moving the object (e.g., a finger) in directions 17 or 15.

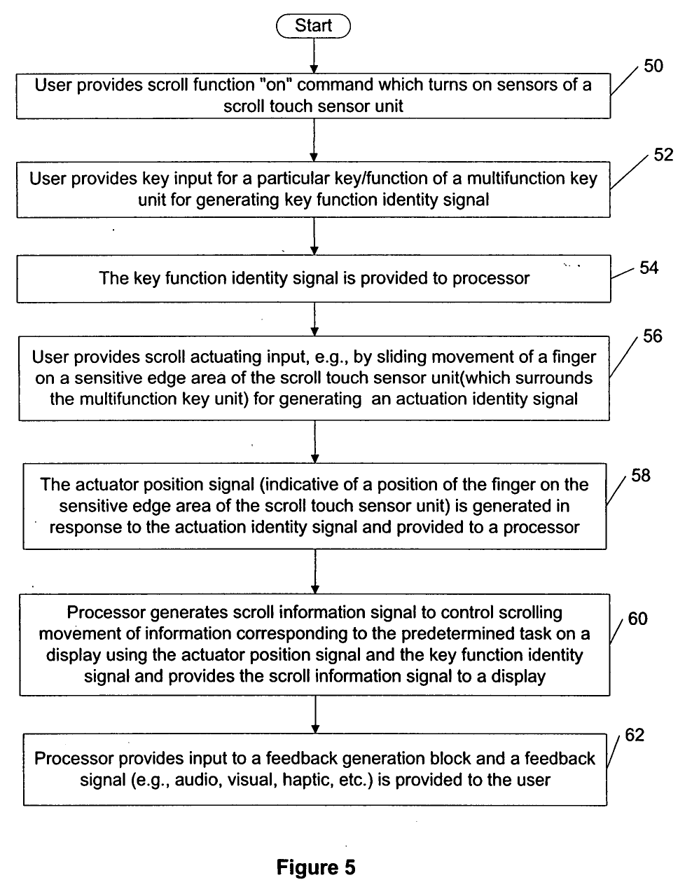

FIG. 5 shows a flow chart combining scrolling with a multi-function key performance, according to an embodiment of the present invention.

The flow chart of FIG. 5 only represents one possible scenario among others. Also the order of steps shown in FIG. 5 is not absolutely required, so in principle, the various steps can be performed out of order. In a method according to the first embodiment of the present invention, in a first step 50, the user provides the scroll function “on” command which turns on sensors of the sensor module 18b.

In a next step 52, the user provides the key input for a particular key/function (predetermined task) of a multifunction key unit 20 for generating the key function identity signal 42. In a next step 54, the key function identity signal is forwarded to the processor 26, e.g., by the key driver and controller 24.

In a next step 56, the user provides the scroll actuating input to the sensitive area 18a of the scroll touch sensor unit 18 (which surrounds the multifunction key unit 20), e.g., using a sliding movement of the object (e.g., a finger) on a sensitive (edge) area 18a of the scroll touch sensor unit 18 for generating the actuation identity signal 36. In a next step 58, the actuator position signal 38 (indicative of a position of the finger on the sensitive edge area 18a of the scroll touch sensor unit 18) is generated in response to the actuation signal 36 and provided to a processor 26.

In a next step 60, the processor 26 generates the scroll information signal to control a scrolling movement of information corresponding to the predetermined task (i.e., to scroll the list) on the display 12 using the actuator position signal 38 and the key function identity signal 42a and provides the scroll information signal 40 to the display 12, wherein the scrolling movement of the information on the display 12 corresponds to the sliding movement of the object according to the predetermined criterion. Finally, in a next step 62, the processor can provide input to the feedback generation block 30 and a feedback signal (e.g., visual, audio, haptic, etc.) regarding scrolling the information can be further provided to the user.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is noted that various embodiments of the present invention recited herein can be used separately, combined or selectively combined for specific applications.

It is to be understood that the above-described arrangements are only illustrative of the application of the principles described by the embodiments of the present invention. Numerous modifications and alternative arrangements may be devised by those skilled in the art without departing from the scope of the present invention, and the appended claims are intended to cover such modifications and arrangements.

What is claimed is:

1. A method, comprising;
providing a key input by a user input action for a multi-function key unit of a scrolling multi-function key module of or connected to an electronic device, said key input selecting a predetermined task;
providing a scroll actuating input by a further user input action using a sliding movement of an object on a sensitive area of a scroll touch sensor unit of said scrolling multi-function key module, wherein said scroll touch sensor unit is configured to have a sensitive area substantially around said multi-function key unit; and
providing, in response to said key input and to said scroll actuating input, a scrolling movement of information corresponding to said predetermined task on a display of said electronic device, wherein said scrolling movement of said information on the display further corresponds to said sliding movement of the object according to a predetermined criterion for combining scrolling with a multi-function key performance in said electronic device.

2. The method of claim 1, wherein said scrolling multi-function key module is connected to said electronic device by an electrical or wireless connection.

3. The method of claim 1, wherein said sliding movement is detected by a plurality of electrodes comprised in a sensor module of said scroll touch sensor unit, wherein said electrodes are arranged in rows and columns to form a matrix and configured to provide Cartesian coordinates of a location of said object during said sliding movement on said sensitive area of the scroll touch sensor unit.

4. The method of claim 3, wherein said plurality of electrodes are capacitive electrodes.

5. The method of claim 3, wherein said plurality of electrodes are four capacitive electrodes.

6. The method of claim 1, wherein said sensitive area has a shape of at least one of:
an edge,
a substantially circular edge,
an edge which completely surrounds said multi-function key unit,
an edge which partially surrounds said multi-function key unit,
an oval edge, and
a substantially rectangular or square edge.

7. The method of claim 1, wherein said multi-function key is one of:
a 5-way navigation key,
a 9-way navigation key, and
an analogue navigation key.

8. The method of claim 1, wherein the key input and the scroll actuating input are provided by a way of a mechanical touch of the object which is at least one of: a stylus and a finger.

9. The method of claim 1, wherein said scroll touch sensor comprises a sensor module configured to detect said sliding movement of the object using at least one of: a resistive sensing method, a capacitive sensing method, a surface acoustic wave sensing method, a pressure sensing method, an optical detection method and an inductive method.

10. The method of claim 1, wherein before said providing said scrolling movement of said information, the method comprises:
determining, according to the predetermined criterion, a rate of said scrolling of said information on the display using a speed of said sliding movement of the object.

11. The method of claim 1, further comprising:
providing a feedback signal about said sliding movement of the object or about said scrolling of said information on the display using at least one of:
a visual feedback,
an audio feedback, and
a haptic feedback.

12. The method of claim 1, wherein said sliding movement of an object on the sensitive area in a clockwise direction corresponds to said scrolling movement of said information on the display in a pre-selected direction, and said sliding movement of an object on the sensitive area in a counter-clockwise direction corresponds to scrolling movement of the information on the display in a further direction opposite to said pre-selected direction.

13. The method of claim 1, wherein said electronic device is configured to alter said predetermined criterion in response to a scroll function input.

14. The method of claim 1, wherein said electronic device is a wireless communication device, a portable electronic device, a non-portable electronic device, a computer, a portable computer, a mobile communication device, a wireless camera phone, or a mobile phone.

15. A computer program product comprising: a computer readable storage structure embodying computer program code thereon for execution by a computer processor with said computer program code, wherein said computer program code comprises instructions for performing the method of claim 1, indicated as being performed by any component or a combination of components of said electronic device.

16. An electronic device, comprising:
a scrolling multi-function key module, comprising:
a multi-function key unit, responsive to a key input provided by a user input action, said key input selecting a predetermined task;
a scroll touch sensor unit, responsive to a scroll actuating input provided by a further user input action using a sliding movement of an object on a sensitive area of said scroll touch sensor unit, wherein said scroll touch sensor unit is configured to have a sensitive area substantially around said multi-function key unit;
a display configured to display information; and
a processor configured to provide a scrolling movement of the information corresponding to said predetermined task on the display, wherein said scrolling movement of said information on the display further corresponds to said sliding movement of the object according to a predetermined criterion for combining scrolling with a multi-function key performance in the electronic device.

17. The electronic device of claim 16, wherein said a scroll touch sensor unit comprises a sensor module with a plurality of electrodes configured to detect said sliding movement, wherein said electrodes are arranged in rows and columns to form a matrix and configured to provide Cartesian coordinates of a location of said object during said sliding movement on said sensitive area.

18. The electronic device of claim 17, wherein said plurality of electrodes are capacitive electrodes.

19. The electronic device of claim 17, wherein said plurality of electrodes are four capacitive electrodes.

20. The electronic device of claim 16, wherein said sensitive area has a shape of at least one of:
an edge,
a substantially circular edge,
an edge which completely surrounds said multi-function key unit,
an edge which partially surrounds said multi-function key unit,
an oval edge, and
a substantially rectangular or square edge.

21. The electronic device of claim 16, wherein said multi-function key is one of:
a 5-way navigation key,
a 9-way navigation key, and
an analogue navigation key.

22. The electronic device of claim 16, wherein the key input and the scroll actuating input are provided by a way of a mechanical touch of the object which is at least one of: a stylus and a finger.

23. The electronic device of claim 16, wherein said scroll touch sensor unit comprises a sensor module configured to detect said sliding movement of the object using at least one of: a resistive sensing method, a capacitive sensing method, a surface acoustic wave sensing method, a pressure sensing method, an optical detection method and an inductive method.

24. The electronic device of claim 16, wherein said processor is configured to determine, according to the predetermined criterion, a rate of said scrolling of said information on the display using a speed of said sliding movement of the object.

25. The electronic device of claim 16, wherein said sliding movement of an object on the sensitive area in a clockwise direction corresponds to said scrolling movement of said information on the display in a pre-selected direction, and said sliding movement of an object on the sensitive area in a counter-clockwise direction corresponds to scrolling movement of the information on the display in a further direction opposite to said pre-selected direction.

26. The electronic device of claim 16, wherein said electronic device is configured to alter said predetermined criterion in response to a scroll function input.

27. A scrolling multi-function key module, comprising:
a multi-function key unit, responsive to a key input provided by a user input action, said key input selecting a predetermined task; and
a scroll touch sensor unit, responsive to a scroll actuating input provided by a further user input action using a sliding movement of an object on a sensitive area of said scroll touch sensor unit, wherein said scroll touch sensor unit is configured to have a sensitive area substantially around said multi-function key unit,
wherein an electronic device is configured to provide a scrolling movement of information corresponding to said predetermined task on a display of the electronic device, wherein said scrolling movement of said information on the display further corresponds to said sliding movement of the object according to a predetermined criterion for combining scrolling with a multi-function key performance in said electronic device.

28. The scrolling multi-function key module of claim 27, wherein said scrolling multi-function key module is a part of said electronic device.

29. The scrolling multi-function key module of claim 27, wherein said scrolling multi-function key module is connected to said electronic device by an electrical or wireless connection.

30. The scrolling multi-function key module of claim 27, wherein said scroll touch sensor unit comprises a sensor module with a plurality of electrodes configured to detect said sliding movement, wherein said electrodes are arranged in rows and columns to form a matrix and configured to provide Cartesian coordinates of a location of said object during said sliding movement on said sensitive area.

31. The scrolling multi-function key module of claim 30, wherein said plurality of electrodes are capacitive sensors.

32. The scrolling multi-function key module of claim 30, wherein said plurality of electrodes are four capacitive sensors.

33. The scrolling multi-function key module of claim 27, wherein said sensitive area has a shape of at least one of:
an edge,
a substantially circular edge,
an edge which completely surrounds said multi-function key unit,
an edge which partially surrounds said multi-function key unit,
an oval edge, and
a substantially rectangular or square edge.

34. The scrolling multi-function key module of claim 27, wherein said multi-function key is one of:
a 5-way navigation key,
a 9-way navigation key, and
an analogue navigation key.

35. The scrolling multi-function key module of claim 27, wherein the key input and the scroll actuating input are provided by a way of a mechanical touch of the object which is at least one of: a stylus and a finger.

36. The scrolling multi-function key module of claim 27, wherein said scroll touch sensor comprises a sensor module configured to detect said sliding movement of the object using a resistive sensing method, a capacitive sensing method, a surface acoustic wave sensing method, a pressure sensing method, an optical detection method or an inductive method.

37. The scrolling multi-function key module of claim 27, wherein said sliding movement of an object on the sensitive area in a clockwise direction corresponds to said scrolling movement of said information on the display in a pre-selected direction, and said sliding movement of an object on the sensitive area in a counter-clockwise direction corresponds to scrolling movement of the information on the display in a further direction opposite to said pre-selected direction.
